(19) United States
(12) Patent Application Publication
(10) Pub. No.: US 2026/0146391 A1
(43) Pub. Date: May 28, 2026

(54) SENSOR-BASED MATERIAL LOADING DETECTION

(71) Applicant: Caterpillar Paving Products Inc., Brooklyn Park, MN (US)

(72) Inventors: Jacob J. McAlpine, Otsego, MN (US); John Lee Marsolek, Watertown, MN (US); Brian D. Nagel, Ramsey, MN (US)

(73) Assignee: Caterpillar Paving Products Inc., Brooklyn Park, MN (US)

(21) Appl. No.: 18/960,178

(22) Filed: Nov. 26, 2024

(51) Int. Cl. E01C 19/48; G01K 3/10; G01K 13/02

(52) U.S. Cl. CPC E01C 19/48; G01K 3/10; G01K 13/02; E01C 2301/02

(57) ABSTRACT

A controller may monitor measurements collected by a sensor that relate to a characteristic of a material in a material holding component of a machine. The controller may detect that the measurements exhibit a change that is indicative of a loading of additional material to the material holding component. The controller may output, responsive to the change being indicative of the loading of the additional material, loading information that indicates at least one of a time or a location of the machine associated with the loading of the additional material.

### TECHNICAL FIELD

The present disclosure relates generally to work machines and, for example, to sensor-based material loading detection.

### BACKGROUND

Paved roadways that are built to facilitate vehicular travel are typically resurfaced from time to time as wear and tear caused by several factors, such as fatigue and freeze-thaw cycles, degrades the surface of the roadway. Many paved roadways consist of an asphalt surface course that is supported by a base course comprising one or more layers of aggregate material deposited on a subgrade of native earth material. After the base course is prepared during a road building operation or after the old surface course is removed during a resurfacing operation, fresh asphalt for the new surface course is laid down using a paving machine and compacted to form a strong, smooth road surface. In many cases, fresh asphalt is produced at a plant and delivered to the worksite in haul trucks while the asphalt is still at a high enough temperature to be effectively laid down and compacted. To ensure the paving process is able to run continuously and efficiently, a continuous and steady flow of fresh asphalt must be delivered to the paver. Thus, there are often several haul trucks participating in the asphalt transport process. For example, while some trucks are picking up fresh material, others are already in transit to the paver with fresh material, while others are emptying their payload or have already done so and are returning to the plant.

When the paver is starved of fresh asphalt, the paving process must be paused, which can cause a chain of events that reduce the efficiency of operations. For example, when the paver stops, compacting operations behind the paver must stop, and road milling operations ahead of the paver may be required to stop (e.g., to avoid milling more road surface than can be repaved in the remaining work time). Idle time reduces efficiency and is often avoided where possible. On the other hand, when too much fresh asphalt accumulates at the worksite, a queue of haul trucks may develop, which can create inconveniences at the worksite and reduce the overall efficiency of the operation (i.e., resulting in idle trucks waiting to dump their payload). Additionally, the hot asphalt in each truck constantly cools over time, and if trucks are required to wait in line too long before dumping their payload (i.e., before the asphalt is used in the paving process), the asphalt can cool below an acceptable usable temperature and may have to be discarded, which is wasteful and costly.

Accordingly, data indicating when and where a paver is loaded with fresh asphalt is useful for efficiently managing logistics for the haul trucks and other machines involved in paving. Generally, this data is obtained through the use of global position systems (GPSs) on the pavers and the haul trucks, perception systems (e.g., cameras), and/or wireless communication between the pavers and the haul trucks. Such systems are complex, costly, prone to inaccuracy, and use significant computing resources in their operation.

International Patent Application Publication No. WO2016042927 (“the ’927 application”) relates to heating an asphalt mixture loading part uniformly to a high temperature in a short time. The ’927 patent describes a heating device which heats an asphalt mixture. The ’927 application does not disclose techniques for monitoring when and where a paver is loaded with fresh asphalt.

The monitoring system of the present disclosure solves one or more of the problems set forth above and/or other problems in the art.

### SUMMARY

A monitoring system may include a temperature sensor configured to measure a temperature of a material in a material holding component of a machine, a global navigation satellite system configured to detect a location of the machine, and a controller. The controller may be configured to detect, using the temperature sensor, that measurements relating to the temperature exhibit a change that is indicative of a loading of additional material to the material holding component. The controller may be configured to identify whether the change in the measurements temporally coincide with a physical adjustment of the material holding component. The controller may be configured to transmit loading information to a remote system responsive to the material holding component having no physical adjustment that temporally coincides with the change in the measurements, where the loading information indicates a time and the location of the machine associated with the loading of the additional material.

A method of material loading detection may include monitoring, by a controller, measurements collected by a sensor that relate to a characteristic of a material in a material holding component of a machine. The method may include detecting, by the controller, that the measurements exhibit a change that is indicative of a loading of additional material to the material holding component. The method may include outputting, by the controller responsive to the change being indicative of the loading of the additional material, loading information that indicates at least one of a time or a location of the machine associated with the loading of the additional material.

A paver may include a hopper to hold material used in a paving operation, the hopper having folding wings configured to fold to provide flow of the material during the paving operation. The paver may include a temperature sensor configured to measure a temperature of the material. The paver may include a controller configured to detect, using the temperature sensor, that measurements relating to the temperature exhibit a change that is indicative of a loading of additional material into the hopper. The controller may be configured to identify whether the change in the measurements temporally coincides with a folding operation for one or more of the folding wings. The controller may be configured to output loading information responsive to the hopper having no folding operation that temporally coincides with the change in the measurements, where the loading information indicates at least one of a time or a location of the paver associated with the loading of the additional material.

### BRIEF DESCRIPTION OF THE DRAWINGS

FIG. 1 is a side elevational view of an example machine.

FIG. 2 shows an example of a monitoring system.

FIG. 3 is a flowchart of an example process associated with sensor-based material loading detection.

### DETAILED DESCRIPTION

This disclosure relates to a monitoring system, which is applicable to any machine that includes a material holding component that can be loaded with material. For example, the machine may be a paver, a cold planer, a dump truck, a haul truck, a material transfer vehicle, or a windrow elevator, among other examples.

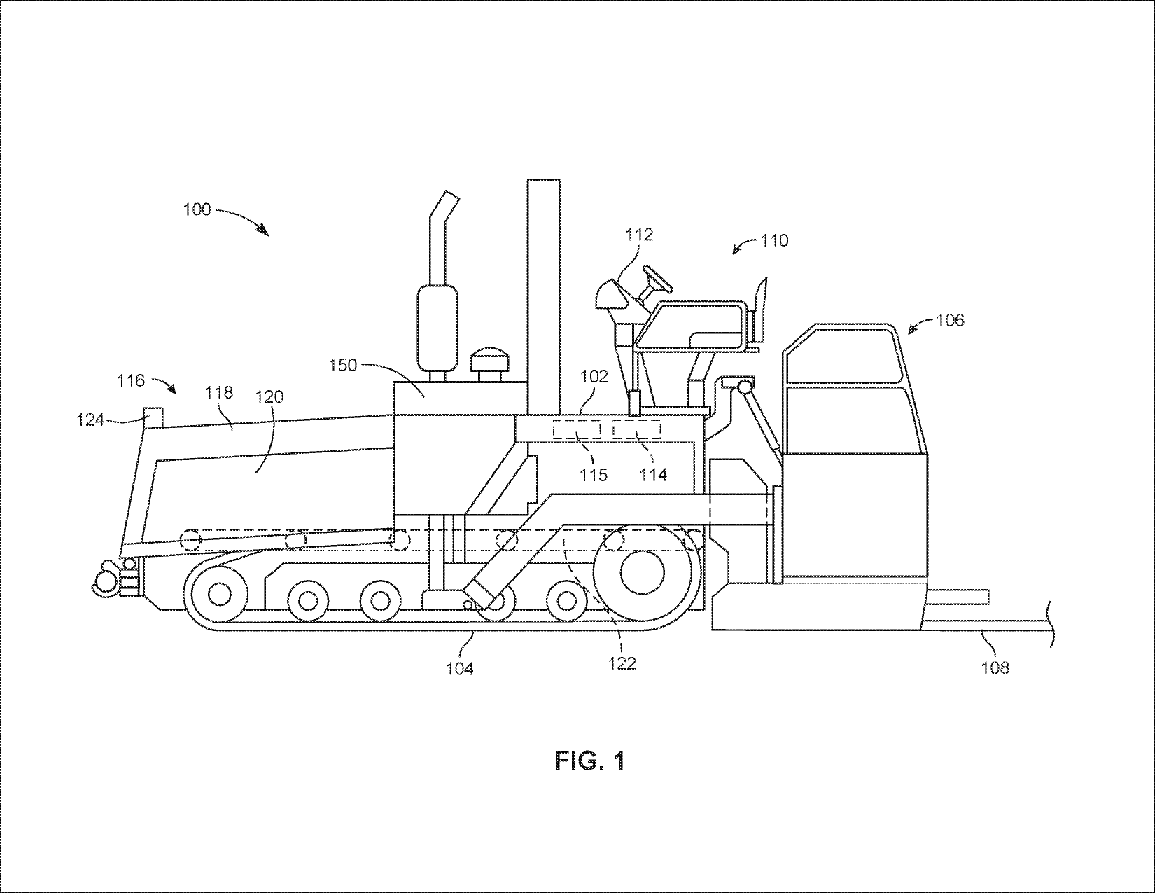

FIG. 1 is a side elevational view of an example machine 100. FIG. 1 shows an example where the machine 100 is a paver. However, as described above, the machine 100 may be another type of machine.

The machine 100 includes a frame 102 with a set of ground-engaging elements 104 such as tracks or wheels coupled with the frame 102. The ground-engaging elements 104 may be driven by a power source 150. The power source 150 may be an engine, such as a diesel engine, a gasoline engine, or a gaseous fuel engine (e.g., a natural gas engine), among other examples. Additionally, or alternatively, the power source 150 may be a fuel cell or an energy storage device (e.g., a battery), among other examples. Additionally, or alternatively, the power source 150 may drive or power another component or system of the machine 100, such as one or more pumps (e.g., of a hydraulic power system of the machine 100) and/or other components described herein.

A screed 106 can be positioned at the rear end of the machine 100 to spread and compact paving material into an asphalt mat 108 having a desired thickness, size, uniformity, crown profile, and cross slope. The machine 100 also includes an operator station 110 having a seat and a console, which includes various controls for directing operations of the machine 100 by inputting instructions at an input panel 112. A controller 114 is provided for electrically controlling various aspects of the machine 100. For example, the controller 114 can send and receive signals from various components of the machine 100 during the operation of the machine 100. In some examples, the machine 100 may include a global navigation satellite system (GNSS) 115 (e.g., a GPS) configured to detect a geographic location of the machine 100. For example, the controller 114 can monitor the location of the machine 100 using the GNSS 115.

The machine 100 further includes a material holding component 116, which is shown as a hopper 118 for storing a paving material (e.g., asphalt) used in a paving operation. The hopper 118 may include one or more folding wings 120 that form side walls of the hopper and that are configured to fold (e.g., rotate inward or outward) to improve flow of the paving material during the paving operation. For example, folding the folding wings 120 may direct paving material onto a conveyor system of the machine 100. The conveyor system may include one or more conveyors 122 configured to move paving material from the hopper 118 to the screed 106 at the rear of the machine 100.

One or more sensors 124 may be mounted on the machine 100 (e.g., on the frame 102 or elsewhere on the machine 100). The sensors 124 may be configured to measure characteristics relating to the machine 100. For example, the one or more sensors 124 may be mounted on the hopper 118 and may be configured to measure characteristics relating to paving material in the hopper 118. In an example of a cold planer, the one or more sensors 124 may be mounted on a conveyor of the cold planer (e.g., the conveyor is a material holding component of the cold planer) to monitor the temperature of recently-milled material being transferred on the conveyer. In an example of a haul truck or a dump truck, the one or more sensors 124 may be mounted on a bed of the haul truck or dump truck (e.g., the bed is a material holding component of the haul truck or dump truck). In an example of a material transfer vehicle, the one or more sensors 124 may be mounted on a conveyor and/or a hopper of the material transfer vehicle (e.g., the conveyor and the hopper are material holding components of the material transfer vehicle). In an example of a windrow elevator, the one or more sensors 124 may be mounted on a conveyor of the windrow elevator (e.g., the conveyor is a material holding component of the windrow elevator).

As indicated above, FIG. 1 is provided as an example. Other examples may differ from what is described with regard to FIG. 1.

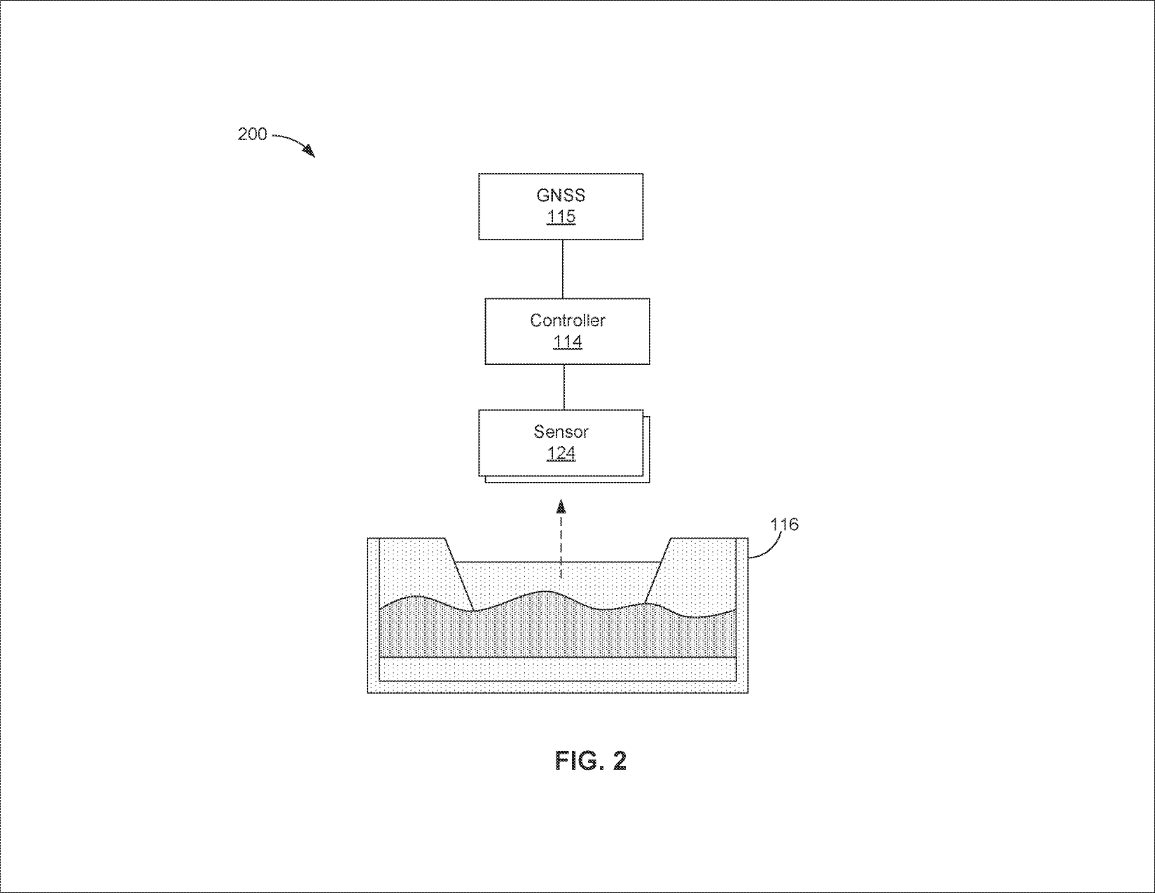

FIG. 2 shows an example of a monitoring system 200 providing monitoring of the material holding component 116 of the machine 100. For example, the material holding component 116 may be the hopper 118 of the machine 100. In other examples, the material holding component 116 may be on a cold planer, a haul truck, a dump truck, a material transfer vehicle, or a windrow elevator, among other examples, as described in connection with FIG. 1. The material holding component 116 may hold (e.g., contain, support, or the like) a material, such as asphalt, dirt, milled roadway, or the like.

The monitoring system 200 may include the controller 114, the GNSS 115, and one or more sensors 124. The controller 114 may be communicatively coupled to the GNSS 115 and the sensors 124 to facilitate the exchange of information between the controller 114 and the GNSS 115 and the sensors 124. The controller 114 may be configured to perform operations associated with material loading detection, as described herein.

The controller 114 may include one or more memories and one or more processors communicatively coupled to the one or more memories. A processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. The processor may be capable of being programmed to perform one or more operations or processes described elsewhere herein. A memory may include volatile and/or nonvolatile memory. For example, the memory may include random access memory (RAM), read only memory (ROM), a hard disk drive, and/or another type of memory (e.g., a flash memory, a magnetic memory, and/or an optical memory). The memory may be a non-transitory computer-readable medium. The memory may store information, one or more instructions, and/or software (e.g., one or more software applications) related to the operation of the controller 114.

The sensors 124 may be configured to collect measurements that relate to a characteristic of a material in the material holding component 116. As an example, the sensors 124 may include a temperature sensor, such as an infrared temperature sensor, a thermocouple, or a thermistor, among other examples. Here, the temperature sensor may be configured to measure a temperature of a material in the material holding component 116. Additionally, or alternatively, the sensors 124 may include a depth sensor, such as an ultrasonic sensor, a lidar system, or a time-of-flight sensor, among other examples. Here, the depth sensor may be configured to measure a distance from the depth sensor to a material in the material holding component 116. In some examples, the sensors 124 may include a camera, which may be configured to capture images of a material in the material holding component 116.

The controller 114 may monitor measurements collected by the sensors 124. The measurements may relate to a characteristic of a material in the material holding component 116 (e.g., a temperature of the material and/or a height of the material). For example, the measurements may relate to a temperature of the material and/or the measurements may relate to a distance from a sensor 124 to the material in the material holding component 116.

The controller 114, based on monitoring the measurements, may detect that the measurements exhibit a change that is indicative of a loading of additional material to the material holding component 116. “Additional material” may refer to material being added to the material holding component 116, either onto older material that is already in the material holding component 116 or into an empty material holding component 116.

To detect that the measurements exhibit the change indicative of loading additional material, the controller 114 may monitor the measurements at a plurality of time points or continuously, and may compare each current measurement with one or more previous measurements (e.g., a single previous measurement, multiple previous measurements, or an average of multiple previous measurements). Continuing with the example, the controller 114 may detect that the measurements exhibit a change indicative of the loading of additional material based on the current measurement differing from the previous measurement(s) by a threshold amount. The threshold may be set to reduce false positives associated with transient measurement changes that are not associated with the loading of additional material. In some examples, the controller 114 may detect that the measurements exhibit the change indicative of loading additional material using a machine learning model trained to identify changes in measurements that indicate loading additional material. Responsive to detecting the change in the measurements, the controller 114 may record or store (e.g., in a memory of the controller 114) a time of the loading of additional material (e.g., a time when the change in measurements is detected or a current time), and a location of the machine 100 at the time of the loading of additional material.

In one example, the controller 114 may detect that measurements relating to a temperature of a material in the material holding component 116 exhibit a change that is indicative of loading additional material to the material holding component 116. For example, a change indicative of loading additional material may be a spike in temperature, which in one example may occur when new hot paving material is added to the hopper 118 onto older paving material that has been in the hopper 118 for sufficient time to have cooled down. In an example involving milling, a spike in temperature may occur when freshly milled ground material, which is heated due to friction associated with the milling, is present on a conveyor of a cold planer (e.g., a lower temperature would be sensed when there is no freshly milled ground material on the conveyor). In this way, temperature changes may provide a simple proxy for detecting when additional material is loaded to the material holding component 116.

Additionally, or alternatively, the controller 114 may detect that measurements relating to a distance (e.g., an average distance, a distance at a single point, or distances at multiple points) between a sensor 124 and the material in the material holding component 116 exhibit a change that is indicative of loading additional material to the material holding component 116. For example, a change indicative of loading additional material may be a sudden large change in the distance, which may occur when new material is added to the material holding component 116 onto older material, thereby changing the total height of the material in the material holding component 116. In this way, distance changes may provide a simple proxy for detecting when additional material is loaded to the material holding component 116.

In some cases, the change in the measurements may be due to an event unrelated to loading additional material, such as a physical adjustment of the material holding component 116. A “physical adjustment” may refer to a change to a shape, size, physical configuration, movement, and/or orientation of the material holding component 116. For example, the physical adjustment may be tilting, vibrating, mixing, or moving the material holding component 116. As one example, the physical adjustment may be a folding operation of the folding wing(s) 120 of the hopper 118. The physical adjustment may cause the sensors 124 to detect a change in the measurements, even though there was no loading of additional material to the material holding component 116.

Accordingly, the controller 114 may identify whether the detected change in the measurements temporally coincides with a physical adjustment of the material holding component 116. For example, the controller 114 may identify whether the detected change in the measurements temporally coincides with a folding operation for the folding wing(s) 120. The change in the measurements temporally coinciding with the physical adjustment may refer to the change in the measurements overlapping in time (e.g., fully or partially) with a duration of an operation for the physical adjustment, or the change in the measurements occurring immediately after (e.g., within a threshold time, such as 2 seconds or 1 second) a completion of the operation.

In some examples, the controller 114 may obtain, via an operator interface (e.g., the input panel 112), a command to perform the operation for the physical adjustment (e.g., the folding operation). The controller 114 may obtain the command at a command time (e.g., a time when the controller 114 receives the command). The controller 114 may then determine whether a relationship, between the command time and the time of the detected loading of additional material, is indicative of the physical adjustment (e.g., the folding operation) temporally coinciding with the change in the measurements. The controller 114 may thus identify whether the change in measurements temporally coincides with the operation (e.g., the folding operation) based on the relationship between the command time and the time. For example, the controller 114 may determine that there is temporal coinciding if the time is within a threshold time of the command time. The threshold time may be based on a duration of the operation (e.g., a folding operation may take 10 seconds to complete, and therefore if the time is within 10 seconds of the command time, the controller 114 may determine that the physical adjustment temporally coincides with the change in the measurements).

In some examples, the controller 114 may cause the physical adjustment of the material holding component 116 (e.g., by outputting a signal that causes actuation of a hydraulic cylinder or another type of actuator). The controller 114 may identify, based on causing the physical adjustment, that the change in measurements temporally coincide with the physical adjustment. For example, the controller 114 may identify that the controller 114 is outputting the signal while the change in the measurements occurs, or that the change in the measurements occurs immediately after (e.g., within a threshold time, such as 2 seconds or 1 second) the controller 114 has stopped outputting the signal.

The controller 114 may output loading information responsive to detecting the loading of additional material (e.g., the change in the measurements is indicative of the loading). The controller may output the loading information to an operator interface (e.g., the input panel 112) or to another device onboard or offboard the machine 100. For example, the controller 114 may transmit the loading information to a remote system (e.g., a user device, a remote control device, a back-office system, a cloud computing system, or the like). Moreover, the controller 114 may output (e.g., transmit) the loading information responsive to the material holding component 116 having no physical adjustment that temporally coincides with the change in the measurements. For example, the controller 114 may output (e.g., transmit) the loading information responsive to the hopper 118 having no folding operation that temporally coincides with the change in the measurements. In some examples, the controller 114 may refrain from outputting (e.g., transmitting) the loading information based on the physical adjustment temporally coinciding with the change in the measurements, which indicates that the physical adjustment, and not the loading of additional material, was the cause of the change in measurements.

The loading information may indicate the time associated with loading additional material and/or the location of the machine 100 associated with loading additional material. The loading information may be used (e.g., by the machine 100 and/or by the remote system) to track how often additional material is loaded to the material holding component 116, how far haul trucks are traveling to load additional material, how long are delays in loading additional material, and/or how much machine idleness is attributable to delay, among other examples. Accordingly, the loading information may be used (e.g., by the machine 100 and/or by the remote system) to generate scheduling for the loading of additional material so as to reduce machine idle time and/or reduce the distance traveled by haul trucks to load additional material. In this way, the loading information facilitates improved utilization of the machine 100 and efficient use of the haul trucks.

In some examples, the loading information may further indicate one or more of the measurements (e.g., measurement(s) collected leading up to the change in measurements and/or measurement(s) collected at or following the change in measurements). For example, these measurements may indicate material temperature correlations with the loading time and location (e.g., which may indicate a duration between loading of a haul truck and the haul truck loading the machine 100 and/or how long the haul truck is waiting to load the machine 100). In some examples, the measurements may be used for training or retraining the machine learning model.

In some examples, the controller 114 may identify an idle time of the machine 100 (e.g., one or more time periods over which the machine 100 is idle). For example, the controller 114 may identify the idle time as times when the machine 100 is stationary (e.g., which can be identified using the GNSS) and/or when the machine 100 is in a park gear (e.g., which can be identified via communication with a transmission controller). The controller 114 may then determine whether the detected loading of additional material temporally coincides with the idle time of the machine 100 (e.g., based on whether the detected loading of additional material falls within a time period of the idle time). During the loading of additional material, there is an expectation that the machine 100 is idle to allow for the loading. However, if the machine 100 is idle at other times, then it may indicate that the machine 100 is not being used efficiently (e.g., the operator is not utilizing the machine efficiently, or there are delays in loading additional material). Accordingly, responsive to the loading of additional material not temporally coinciding with the idle time, the controller 114 may output a notification indicating excessive machine idle time. This notification may be output on an operator interface (e.g., the input panel 112), or transmitted to the remote device.

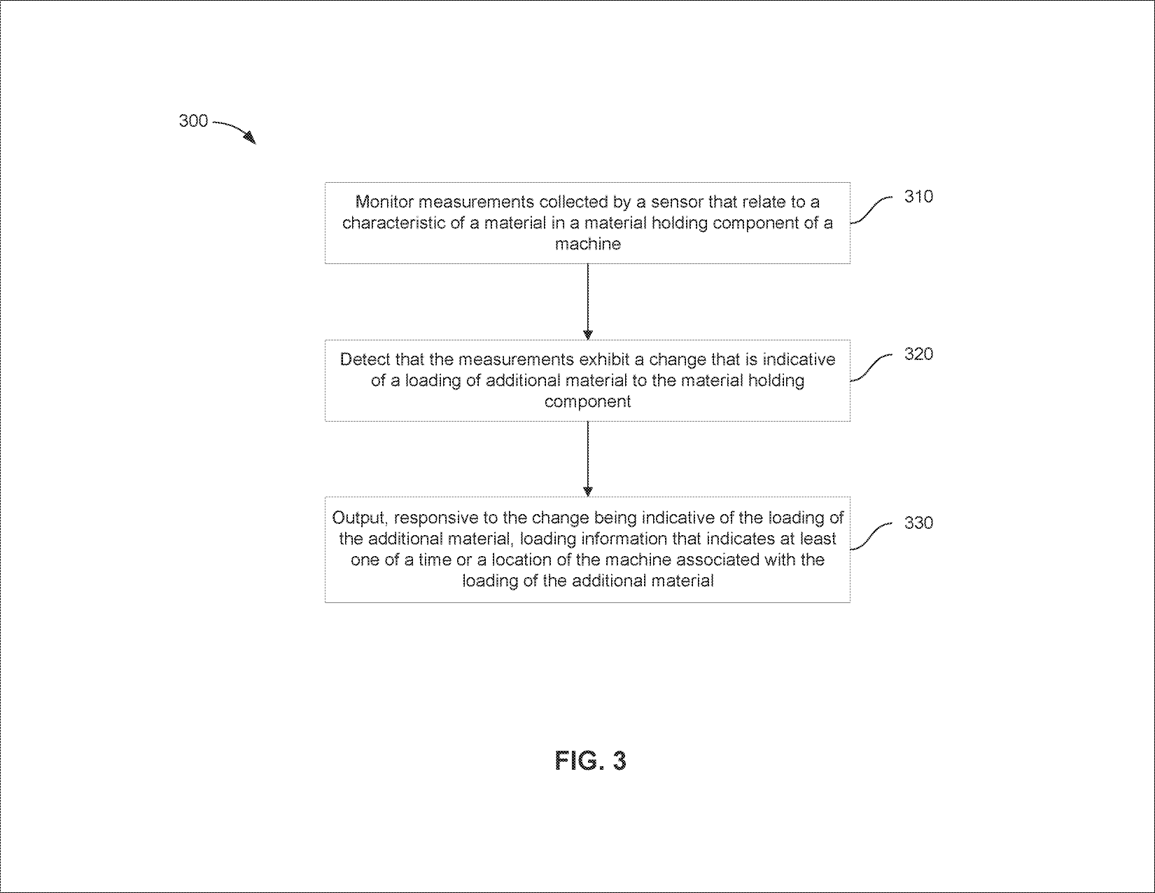

FIG. 3 is a flowchart of an example process 300 associated with sensor-based material loading detection. One or more steps of process 300 may be performed by one or more controllers (e.g., controller 114). Additionally, or alternatively, one or more steps of process 300 may be performed by another device or a group of devices separate from or including the controller(s), such as another device or component that is internal or external to the machine 100.

At step 310, process 300 may include monitoring (e.g., using the controller 114 and/or one or more sensors 124) measurements collected by a sensor 124 that relate to a characteristic of a material in a material holding component 116 of a machine 100.

At step 320, process 300 may include detecting (e.g., using the controller 114 and/or one or more sensors 124) that the measurements exhibit a change that is indicative of a loading of additional material to the material holding component 116. For example, process 300 may include monitoring (e.g., using the controller 114 and/or one or more sensors 124) the measurements, comparing (e.g., using the controller 114) a measurement, of the measurements, to one or more previous measurements of the measurements, and detecting (e.g., using the controller 114) that the measurements exhibit the change that is indicative of the loading of the additional material based on the measurement differing from the one or more previous measurements by a threshold amount. In some examples, process 300 may include detecting (e.g., using the controller 114 and/or one or more sensors 124) that measurements relating to a temperature, and additional measurements relating to a distance (e.g., collected by a depth sensor), both exhibit changes that are indicative of the loading of the additional material.

At step 330, process 300 may include outputting (e.g., using the controller 114 and/or the GNSS 115), responsive to the change being indicative of the loading of the additional material, loading information that indicates at least one of a time or a location of the machine 100 associated with the loading of the additional material. In some examples, process 300 may include identifying (e.g., using the controller 114) whether the change in the measurements temporally coincides with a physical adjustment of the material holding component 116. Here, process 300 may include outputting (e.g., using the controller 114 and/or the GNSS 115) the loading information responsive to the change being indicative of the loading of the additional material and responsive to the material holding component 116 having no adjustment that temporally coincides with the change. To identify whether the change in the measurements temporally coincides with the physical adjustment of the material holding component 116, process 300 may include obtaining (e.g., using the controller 114), via an operator interface at a command time, a command to perform an adjustment operation, determining (e.g., using the controller 114) whether a relationship between the command time and the time is indicative of the adjustment operation temporally coinciding with the change in the measurements, and identifying (e.g., using the controller 114) whether the change in the measurements temporally coincides with the adjustment operation based on the relationship between the command time and the time.

In some examples, process 300 may include causing (e.g., using the controller 114 and/or an actuator of the machine 100) the physical adjustment of the material holding component 116, identifying (e.g., using the controller 114), based on causing the physical adjustment, that the change in the measurements temporally coincide with the physical adjustment, and refraining (e.g., using the controller 114) from transmitting the loading information based on the physical adjustment temporally coinciding with the change in the measurements.

Process 300 may include identifying (e.g., using the controller 114) an idle time of the machine 100, determining (e.g., using the controller 114) whether the loading of the additional material temporally coincides with the idle time of the machine 100, and outputting (e.g., using the controller 114) a notification (e.g., indicating excessive machine idle time) responsive to the loading of the additional material not temporally coinciding with the idle time.

Although FIG. 3 shows example steps of process 300, in some implementations, process 300 may include additional steps, fewer steps, different steps, or differently arranged steps than those depicted in FIG. 3. Additionally, or alternatively, two or more of the steps of process 300 may be performed in parallel.

### INDUSTRIAL APPLICABILITY

The monitoring system 200 described herein may be used with any machine that includes a material holding component (e.g., a hopper, a bed, a conveyor, or the like). For example, the monitoring system 200 may be used with a paver involved in a paving process associated with a roadway, a parking lot, or the like. Data indicating when and where the paver is loaded with fresh asphalt is useful for efficiently managing logistics for haul trucks and other machines involved in paving. Generally, this data is obtained through the use of GPSs on the pavers and the haul trucks, perception systems (e.g., cameras), and/or wireless communication between the pavers and the haul trucks. Such systems are complex, costly, prone to inaccuracy, and use significant computing resources in their operation.

The monitoring system 200 is useful for monitoring and detecting the loading of material to a material holding component (e.g., a hopper of a paver). The monitoring system 200 may use a simple temperature sensor (e.g., an infrared sensor) and/or depth sensor (e.g., an ultrasonic sensor) mounted on the material holding component to detect the loading of material based on spikes in the measurements collected by the sensor. In particular, the monitoring system 200 may use changes in temperature and/or material height as a proxy for detecting when material is loaded to the material holding component. In this way, the monitoring system 200 provides a simple, low-cost technique for detecting material loading that has minimal computing needs and that is not prone to failures or outages that other more complex systems may experience.

Moreover, the monitoring system 200 is capable of accurate detection, particularly through the identification of false positives. For example, the monitoring system 200 may detect when spikes in the measurements are responsive to an event unrelated to loading material, such as a physical adjustment of the material holding component. The monitoring system 200 may refrain from collecting, storing, and/or transmitting information about material loading when the spikes in the measurements are responsive to an event unrelated to loading material, thereby improving an accuracy of the material loading detection and conserving computing and networking resources that otherwise may be expended responding to a false positive.

The foregoing describes only some embodiments, and alterations, modifications, additions and/or changes can be made thereto without departing from the scope and spirit of the disclosed embodiments, the embodiments being illustrative and not restrictive. Furthermore, implementations are not limited to the disclosed embodiments, and may cover various modifications and equivalent arrangements included within the spirit and scope of the disclosed embodiments. Also, the various embodiments described above may be implemented in conjunction with other embodiments, for example, aspects of one embodiment may be combined with aspects of another embodiment to realize yet other embodiments. Further, each independent feature or component of any given assembly or process may constitute an additional embodiment. As used herein, the singular forms of “a,” “an,” and “the” include plural referents unless the context clearly dictates otherwise. In addition, as used herein, the term “or” means “and/or” unless the context clearly dictates otherwise.

When “a controller” or “one or more controllers” is described or claimed (within a single claim or across multiple claims) as performing multiple operations or being configured to perform multiple operations, unless described or claimed otherwise (e.g., via the use of “first controller” and “second controller” or other language that differentiates controllers) this language is intended to cover a single controller performing or being configured to perform all of the operations, a group of controllers collectively performing or being configured to perform all of the operations, a first controller performing or being configured to perform a first operation and a second controller performing or being configured to perform a second operation, or any combination of controllers performing or being configured to perform the operations.

What is claimed is:

1. A monitoring system, comprising:
a temperature sensor configured to measure a temperature of a material in a material holding component of a machine;
a global navigation satellite system configured to detect a location of the machine; and
a controller configured to:
detect, using the temperature sensor, that measurements relating to the temperature exhibit a change that is indicative of a loading of additional material to the material holding component;
identify whether the change in the measurements temporally coincide with a physical adjustment of the material holding component; and
transmit loading information to a remote system responsive to the material holding component having no physical adjustment that temporally coincides with the change in the measurements,
wherein the loading information indicates a time and the location of the machine associated with the loading of the additional material.

2. The monitoring system of claim 1, wherein the machine is a paver and the material holding component is a hopper of the paver.

3. The monitoring system of claim 2, wherein the physical adjustment is a folding operation for one or more folding wings of the hopper.

4. The monitoring system of claim 1, wherein the controller is further configured to:
identify an idle time of the machine;
determine whether the loading of the additional material temporally coincides with the idle time of the machine; and
output a notification responsive to the loading of the additional material not temporally coinciding with the idle time, wherein the notification indicates excessive machine idle time.

5. The monitoring system of claim 1, wherein the controller, to detect that the measurements exhibit the change that is indicative of the loading of the additional material, is configured to:
monitor the measurements;
compare a measurement, of the measurements, to one or more previous measurements of the measurements; and
detect that the measurements exhibit the change that is indicative of the loading of the additional material based on the measurement differing from the one or more previous measurements by a threshold amount.

6. The monitoring system of claim 1, wherein the temperature sensor is an infrared sensor.

7. The monitoring system of claim 1, wherein the controller, to identify whether the change in the measurements temporally coincide with the physical adjustment of the material holding component, is further configured to:
cause the physical adjustment of the material holding component;
identify, based on causing the physical adjustment, that the change in the measurements temporally coincide with the physical adjustment; and
refrain from transmitting the loading information based on the physical adjustment temporally coinciding with the change in the measurements.

8. The monitoring system of claim 1, further comprising a depth sensor configured to measure a distance to the material in the material holding component,
wherein the controller, to detect that the measurements relating to the temperature exhibit the change that is indicative of the loading of the additional material, is configured to:
detect that the measurements relating to the temperature, and additional measurements relating to the distance, both exhibit changes that are indicative of the loading of the additional material into the material holding component.

9. The monitoring system of claim 1, wherein the machine is a cold planer, and
wherein the temperature sensor is positioned on a conveyor of the cold planer.

10. A method of material loading detection, comprising:
monitoring, by a controller, measurements collected by a sensor that relate to a characteristic of a material in a material holding component of a machine;
detecting, by the controller, that the measurements exhibit a change that is indicative of a loading of additional material to the material holding component; and
outputting, by the controller responsive to the change being indicative of the loading of the additional material, loading information that indicates at least one of a time or a location of the machine associated with the loading of the additional material.

11. The method of claim 10, further comprising:
identifying whether the change in the measurements temporally coincides with a physical adjustment of the material holding component,
wherein outputting the loading information comprises:
outputting the loading information responsive to the change being indicative of the loading of the additional material and responsive to the material holding component having no adjustment that temporally coincides with the change.

12. The method of claim 10, wherein the characteristic is one or more of:
a temperature of the material, or
a height of the material in the material holding component.

13. The method of claim 10, wherein the sensor is an infrared sensor or an ultrasonic sensor.

14. The method of claim 10, wherein detecting that the measurements exhibit the change that is indicative of the loading of the additional material comprises:
monitoring the measurements;
comparing a measurement, of the measurements, to one or more previous measurements of the measurements; and
detecting that the measurements exhibit the change that is indicative of the loading of the additional material based on the measurement differing from the one or more previous measurements by a threshold amount.

15. The method of claim 10, wherein the machine is a paver and the material holding component is a hopper of the paver.

16. A paver, comprising:
a hopper to hold material used in a paving operation, the hopper having folding wings configured to fold to provide flow of the material during the paving operation;
a temperature sensor configured to measure a temperature of the material; and
a controller configured to:
detect, using the temperature sensor, that measurements relating to the temperature exhibit a change that is indicative of a loading of additional material into the hopper;
identify whether the change in the measurements temporally coincides with a folding operation for one or more of the folding wings; and
output loading information responsive to the hopper having no folding operation that temporally coincides with the change in the measurements,
wherein the loading information indicates at least one of a time or a location of the paver associated with the loading of the additional material.

17. The paver of claim 16, further comprising a global navigation satellite system (GNSS),
wherein the controller is further configured to:
monitor the location of the paver using the GNSS.

18. The paver of claim 16, wherein the controller, to identify whether the change in the measurements temporally coincides with the folding operation, is configured to:
obtain, via an operator interface and at a command time, a command to perform the folding operation;
determine whether a relationship between the command time and the time is indicative of the folding operation temporally coinciding with the change in the measurements; and
identify whether the change in the measurements temporally coincides with the folding operation based on the relationship between the command time and the time.

19. The paver of claim 16, further comprising a depth sensor configured to measure a distance to the material in the hopper,
wherein the controller, to detect that the measurements relating to the temperature exhibit the change that is indicative of the loading of the additional material into the hopper, is configured to:
detect that the measurements relating to the temperature, and additional measurements relating to the distance, both exhibit changes that are indicative of the loading of the additional material into the hopper.

20. The paver of claim 16, wherein the controller, to detect that the measurements exhibit the change that is indicative of the loading of the additional material, is configured to:
monitor the measurements;
compare a measurement, of the measurements, to one or more previous measurements of the measurements; and
detect that the measurements exhibit the change that is indicative of the loading of the additional material based on the measurement differing from the one or more previous measurements by a threshold amount.
